(19) United States
(12) Patent Application Publication
(10) Pub. No.: US 2020/0145623 A1
(43) Pub. Date: May 7, 2020

(54) Method and System for Initiating a Video Stream

(71) Applicant: Avigilon Corporation, Vancouver (CA)

(72) Inventor: Sreemanananth SADANAND, Malden, MA (US)

(73) Assignee: Avigilon Corporation, Vancouver (CA)

(21) Appl. No.: 16/183,371

(22) Filed: Nov. 7, 2018

(51) Int. Cl. H04N 7/18; G06K 9/00; H04N 5/232; G06T 7/292

(52) U.S. Cl. CPC H04N 7/188; H04N 7/181; G06K 9/00771; G06K 9/6215; H04N 5/23296; G06T 7/292; G06T 2207/30232; H04N 5/23299

(57) ABSTRACT

There are described methods, systems, and computer-readable media for generating a video stream. A selection of a portion of a field of view of a primary video stream is received. An object of interest in the portion that has been selected is identified. An event associated with the object of interests is detected in the selected portion. In response thereto, a secondary video stream having a field of view that comprises the selected portion is initiated.

### TECHNICAL FIELD

The present subject-matter relates to video surveillance, and more particularly to initiating a video stream, for example for tracking movement of an object of interest.

### BACKGROUND

Automated security and surveillance systems typically employ video cameras or other image capturing devices or sensors to collect image data such as video or video footage. In the simplest systems, images represented by the image data are displayed for contemporaneous screening by security personnel and/or recorded for later review after a security breach. In those systems, the task of detecting and classifying visual objects of interest is performed by a human observer. A significant advance occurs when the system itself is able to perform object detection and classification, either partly or completely.

In a typical surveillance system, one may be interested in detecting and tracking objects such as humans, vehicles, animals, etc. that move through the environment. However, if for example an object of interest is stationary, then expending computer resources to track the stationary object can be wasteful, when such resources could be used for the detection, classification, and tracking of other objects.

The present disclosure seeks to provide a method and system for initiating a video stream that may be used for tracking movement of an object of interest.

### SUMMARY

In embodiments, methods and systems of the disclosure allow an end user to select, from a primary video stream, specific stationary objects of interest in the scene under observation. The objects are detected, tracked and presented to the user, via one or more secondary video streams, once they start moving or performing a selected action. The methods and systems described herein therefore address a common problem of an end user having to maintain constant attention on a stationary target while waiting for the target to move or perform an action of interest. Since such targets are liable to move at an arbitrary time, the user is typically forced to maintain constant vigilance until the target begins to move. The methods and systems described herein simplify for the end user the task of visually tracking the target before and after it starts moving.

In a first aspect of the disclosure, there is provided a method comprising: receiving a selection of a portion of a field of view of a primary video stream; identifying an object of interest within the portion that has been selected; detecting, in the selected portion, an event associated with the object of interest; and in response to detecting the event, initiating a secondary video stream having a field of view that comprises the selected portion.

The field of view of the secondary video stream may correspond to the selected portion. For example, the field of view of the secondary video stream may have the same size as the selected portion. The field of view of the secondary video stream may consist of the selected portion.

The method may further comprise recording the secondary video stream.

Receiving the selection of the portion may comprise receiving a selection of a boundary defining the portion of the field of view of the primary video stream. For example, the boundary may comprise a quadrilateral (e.g. a bounding box) defining a portion of the field of view of the primary video stream

The method may further comprise classifying the object of interest.

The event may comprise movement of the object of interest.

The event may comprise a speed of the object of interest exceeding a threshold.

The method may further comprise defining a boundary within the selected portion, and the event may comprise the object of interest moving at least partially across the boundary.

The method may further comprise adjusting the field of view of the secondary video stream so as to track movement of the object of interest. Adjusting the field of view may comprise one or more of panning the field of view, tilting the field of view, and zooming the field of view.

The method may further comprise displaying the secondary video stream. The secondary video stream may be displayed concurrently to display of the primary video stream.

The method may further comprise, in response to detecting the event, notifying a user. Notifying the user may comprise displaying the secondary video stream.

The method may further comprise: receiving one or more additional selections of portions of the field of view of the primary video stream; identifying one or more additional objects of interest within the one or more portions that have been additionally selected; and detecting one or more additional events in the one or more additional selected portions. The method may further comprise, in response to detecting the one or more additional events, initiating one or more additional secondary video streams each having a field of view that comprises at least one of the one or more additional selected portions. The method may further comprise, in response to detecting the one or more additional events, adjusting the field of view of the secondary video stream so as to track movement of the object of interest and movement of an additional object of interest within at least one of the one or more additional selected portions.

The method may further comprise: determining that the object of interest has exited a maximum field of view of the primary video stream; generating signatures of the object of interest; generating signatures of one or more identified objects in one or more other video streams; comparing the signatures of the one or more identified objects with the signatures of the object of interest to generate similarity scores for the one or more identified objects; and based on the similarity scores, initiating one or more additional secondary video streams each having a field of view that comprises at least one of the one or more identified objects.

The method may further comprise: prior to the object of interest exiting a maximum field of view of the primary video stream, determining one or more of a speed of the object of interest, a direction of travel of the object of interest, and signatures of the object of interest; determining that the object of interest has exited the maximum field of view; in response to determining that the object of interest has exited the maximum field of view, identifying the object of interest in another video stream based on one or more of: a speed of an object in the other video stream, a direction of travel of an object in the other video stream, and signatures of an object in the other video stream; and initiating an additional secondary video stream having a field of view that comprises the identified object of interest.

In a further aspect of the disclosure, there is provided a system comprising: a camera configured to generate a primary video stream; and one or more processors communicative with memory and configured to: receive a selection of a portion of a field of view of the primary video stream; identify an object of interest within the portion that has been selected; detect, in the selected portion, an event associated with the object of interest; and in response to detecting the event, initiate a secondary video stream having a field of view that comprises the selected portion.

The one or more processors and the memory may be comprised in the camera.

The camera may be configured to transmit over a network the primary video stream to the one or more processors.

The system may comprise any of the features described above in connection with the first aspect of the disclosure.

In a further aspect of the disclosure, there is provided a computer-readable medium having stored thereon computer program code configured when read by one or more processors to cause the one or more processors to perform a method comprising: receiving a selection of a portion of a field of view of a primary video stream; identifying an object of interest within the portion that has been selected; detecting, in the selected portion, an event associated with the object of interest; and in response to detecting the event, initiating a secondary video stream having a field of view that comprises the selected portion.

The method may comprise any of the features described above in connection with the first aspect of the disclosure.

In a further aspect of the disclosure, there is provided a method comprising: displaying, on a display, a field of view of a primary video stream; receiving, via a user input device, a selection of a portion of the field of view; identifying an object of interest within the portion that has been selected; detecting, in the selected portion, an event associated with the object of interest; and in response to detecting the event, initiating, on a display, a secondary video stream having a field of view that comprises the selected portion.

The field of view of the secondary video stream may correspond to or consist of the selected portion.

Receiving the selection of the portion of the field of view may comprise receiving a selection of a boundary defining the portion of the field of view of the primary video stream.

The method may further comprise classifying the object of interest.

The event may comprise movement of the object of interest. The method may further comprise adjusting, on the display, the field of view of the secondary video stream so as to track movement of the object of interest. Adjusting the field of view may comprise one or more of panning the field of view, tilting the field of view, and zooming the field of view.

The secondary video stream may be displayed concurrently to display of the primary video stream.

The method may further comprise: receiving, via a user input device, one or more additional selections of portions of the field of view of the primary video stream; identifying one or more additional objects of interest within the one or more portions that have been additionally selected; and detecting, in the one or more additional selected portions, one or more additional events associated with the one or more additional objects of interest. The method may further comprise, in response to detecting the one or more additional events, initiating, on a display, one or more additional secondary video streams each having a field of view that comprises at least one of the one or more additional selected portions.

The method may further comprise, in response to detecting the one or more additional events, adjusting, on the display, the field of view of the secondary video stream so as to track movement of the object of interest and movement of an additional object of interest within at least one of the one or more additional selected portions.

The method may further comprise: determining that the object of interest has exited a maximum field of view of the primary video stream; generating one or more signatures of the object of interest; generating one or more signatures of one or more identified objects in one or more other video streams; comparing the one or more signatures of the one or more identified objects with the one or more signatures of the object of interest to generate similarity scores for the one or more identified objects; and based on the similarity scores, initiating, on a display, one or more additional secondary video streams each having a field of view that comprises at least one of the one or more identified objects.

The method may further comprise: prior to the object of interest exiting a maximum field of view of the primary video stream, determining one or more of a speed of the object of interest, a direction of travel of the object of interest, and one or more signatures of the object of interest; determining that the object of interest has exited the maximum field of view; in response to determining that the object of interest has exited the maximum field of view, identifying the object of interest in another video stream based on one or more of: a speed of an object in the other video stream, a direction of travel of an object in the other video stream, and one or more signatures of an object in the other video stream; and initiating, on a display, an additional secondary video stream having a field of view that comprises the identified object of interest.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

The detailed description refers to the following figures, in which:

FIG. 1 illustrates a block diagram of connected devices of a video capture and playback system according to an example embodiment;

FIG. 2A illustrates a block diagram of a set of operational modules of the video capture and playback system according to one example embodiment;

FIG. 2B illustrates a block diagram of a set of operational modules of the video capture and playback system according to one particular example embodiment wherein the video analytics module 224, the video management module 232 and the storage 240 is implemented on the one or more image capture devices 108;

FIG. 2C illustrates a block diagram of a set of operational modules of the video analytics module 224, according to one example embodiment;

FIG. 3 illustrates a scene from a primary video stream;

FIG. 4 illustrates the scene of FIG. 3, with a bounding box;

FIG. 5 illustrates a first embodiment of a primary video stream displayed concurrently to a secondary video stream;

FIG. 6 illustrates another embodiment of a primary video stream displayed concurrently with a secondary video stream; and

FIG. 7 is a flow diagram of a method of initiating a video stream for tracking movement of a target, in accordance with an embodiment of the disclosure.

It will be appreciated that for simplicity and clarity of illustration, elements shown in the figures have not necessarily been drawn to scale. For example, the dimensions of some of the elements may be exaggerated relative to other elements for clarity. Furthermore, where considered appropriate, reference numerals may be repeated among the figures to indicate corresponding or analogous elements.

### DETAILED DESCRIPTION

Numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending in the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through one or more intermediate elements or devices via an electrical element, electrical signal or a mechanical element depending on the particular context.

Herein, an image may include a plurality of sequential image frames, which together form a video captured by the video capture device. Each image frame may be represented by a matrix of pixels, each pixel having a pixel image value. For example, the pixel image value may be a numerical value on grayscale (e.g., 0 to 255) or a plurality of numerical values for colored images. Examples of color spaces used to represent pixel image values in image data include RGB, YUV, CYKM, YCBCR 4:2:2, YCBCR 4:2:0 images.

“Metadata” or variants thereof herein refers to information obtained by computer-implemented analysis of images including images in video. For example, processing video may include, but is not limited to, image processing operations, analyzing, managing, compressing, encoding, storing, transmitting and/or playing back the video data. Analyzing the video may include segmenting areas of image frames and detecting visual objects, tracking and/or classifying visual objects located within the captured scene represented by the image data. The processing of the image data may also cause additional information regarding the image data or visual objects captured within the images to be output. For example, such additional information is commonly understood as metadata. The metadata may also be used for further processing of the image data, such as drawing bounding boxes around detected objects in the image frames.

As will be appreciated by one skilled in the art, the various example embodiments described herein may be embodied as a method, system, or computer program product. Accordingly, the various example embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the various example embodiments may take the form of a computer program product on a computer-usable storage medium having computer-usable program code embodied in the medium

Any suitable computer-usable or computer readable medium may be utilized. The computer-usable or computer-readable medium may be, for example but not limited to, an electronic, magnetic, optical, electromagnetic, infrared, or semiconductor system, apparatus, device, or propagation medium. In the context of this document, a computer-usable or computer-readable medium may be any medium that can contain, store, communicate, propagate, or transport the program for use by or in connection with the instruction execution system, apparatus, or device.

Computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

Various example embodiments are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

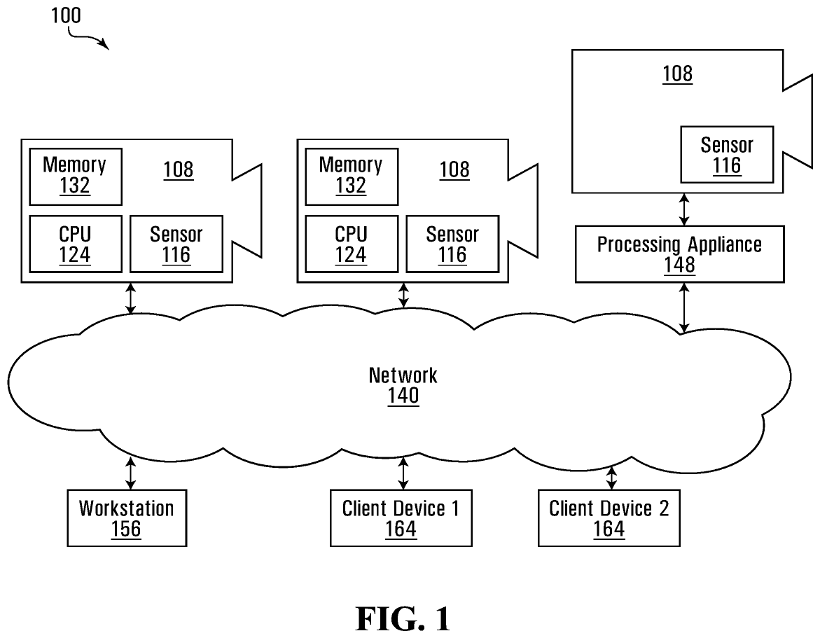

Referring now to FIG. 1, therein illustrated is a block diagram of connected devices of a video capture and playback system 100 according to an example embodiment. For example, the video capture and playback system 100 may be used as a video surveillance system. The video capture and playback system 100 includes hardware and software that perform the processes and functions described herein.

The video capture and playback system 100 includes at least one video capture device 108 (also referred to as “camera 108”) being operable to capture a plurality of images and produce image data representing the plurality of captured images. The video capture device 108 or camera 108 is an image capturing device and includes security video cameras.

Each video capture device 108 includes at least one image sensor 116 for capturing a plurality of images. The video capture device 108 may be a digital video camera and the image sensor 116 may output captured light as a digital data. For example, the image sensor 116 may be a CMOS, NMOS, or CCD. In some embodiments, the video capture device 108 may be an analog camera connected to an encoder.

The at least one image sensor 116 may be operable to capture light in one or more frequency ranges. For example, the at least one image sensor 116 may be operable to capture light in a range that substantially corresponds to the visible light frequency range. In other examples, the at least one image sensor 116 may be operable to capture light outside the visible light range, such as in the infrared and/or ultraviolet range. In other examples, the video capture device 108 may be a multi-sensor camera that includes two or more sensors that are operable to capture light in different frequency ranges.

The at least one video capture device 108 may include a dedicated camera. It will be understood that a dedicated camera herein refers to a camera whose principal features is to capture images or video. In some example embodiments, the dedicated camera may perform functions associated to the captured images or video, such as but not limited to processing the image data produced by it or by another video capture device 108. For example, the dedicated camera may be a surveillance camera, such as any one of a pan-tilt-zoom camera, dome camera, in-ceiling camera, box camera, and bullet camera.

Additionally, or alternatively, the at least one video capture device 108 may include an embedded camera. It will be understood that an embedded camera herein refers to a camera that is embedded within a device that is operational to perform functions that are unrelated to the captured image or video. For example, the embedded camera may be a camera found on any one of a laptop, tablet, drone device, smartphone, video game console or controller.

Each video capture device 108 includes one or more processors 124, one or more memory devices 132 coupled to the processors, and one or more network interfaces. The memory device can include a local memory (such as, for example, a random access memory and a cache memory) employed during execution of program instructions. The processor executes computer program instructions (such as, for example, an operating system and/or application programs), which can be stored in the memory device.

In various embodiments the processor 124 may be implemented by any suitable processing circuit having one or more circuit units, including a digital signal processor (DSP), graphics processing unit (GPU), video processing unit, or vision processing unit (VPU) embedded processor, etc., and any suitable combination thereof operating independently or in parallel, including possibly operating redundantly. Such processing circuit may be implemented by one or more integrated circuits (IC), including being implemented by a monolithic integrated circuit (MIC), an Application Specific Integrated Circuit (ASIC), a Field Programmable Gate Array (FPGA), etc. or any suitable combination thereof. Additionally or alternatively, such processing circuit may be implemented as a programmable logic controller (PLC), for example. The processor may include circuitry for storing memory, such as digital data, and may comprise the memory circuit or be in wired communication with the memory circuit, for example.

In various example embodiments, the memory device 132 coupled to the processor circuit is operable to store data and computer program instructions. Typically, the memory device is all or part of a digital electronic integrated circuit or formed from a plurality of digital electronic integrated circuits. The memory device may be implemented as Read-Only Memory (ROM), Programmable Read-Only Memory (PROM), Erasable Programmable Read-Only Memory (EPROM), Electrically Erasable Programmable Read-Only Memory (EEPROM), flash memory, one or more flash drives, universal serial bus (USB) connected memory units, magnetic storage, optical storage, magneto-optical storage, etc. or any combination thereof, for example. The memory device may be operable to store memory as volatile memory, non-volatile memory, dynamic memory, etc. or any combination thereof.

In various example embodiments, a plurality of the components of the image capture device 108 may be implemented together within a system on a chip (SOC). For example, the processor 124, the memory device 116 and the network interface may be implemented within a SOC. Furthermore, when implemented in this way, a general purpose processor and one or more of a GPU and a DSP may be implemented together within the SOC.

Continuing with FIG. 1, each of the at least one video capture device 108 is connected to a network 140. Each video capture device 108 is operable to output image data representing images that it captures and transmit the image data over the network.

It will be understood that the network 140 may be any suitable communications network that provides reception and transmission of data. For example, the network 140 may be a local area network, external network (such as, for example, a WAN, or the Internet) or a combination thereof. In other examples, the network 140 may include a cloud network.

In some examples, the video capture and playback system 100 includes a processing appliance 148. The processing appliance 148 is operable to process the image data output by a video capture device 108. The processing appliance 148 also includes one or more processors and one or more memory devices coupled to a processor (CPU). The processing appliance 148 may also include one or more network interfaces. For convenience of illustration, only one processing appliance 148 is shown; however it will be understood that the video capture and playback system 100 may include any suitable number of processing appliances 148.

For example, and as illustrated, the processing appliance 148 is connected to a video capture device 108 which may not have memory 132 or CPU 124 to process image data. The processing appliance 148 may be further connected to the network 140.

According to one exemplary embodiment, and as illustrated in FIG. 1, the video capture and playback system 100 includes at least one workstation 156 (such as, for example, a server), each having one or more processors including GPUs or VPUs. The at least one workstation 156 may also include storage memory. The workstation 156 receives image data from at least one video capture device 108 and performs processing of the image data. The workstation 156 may further send commands for managing and/or controlling one or more of the image capture devices 108. The workstation 156 may receive raw image data from the video capture device 108. Alternatively, or additionally, the workstation 156 may receive image data that has already undergone some intermediate processing, such as processing at the video capture device 108 and/or at a processing appliance 148. The workstation 156 may also receive metadata from the image data and perform further processing of the image data.

It will be understood that while a single workstation 156 is illustrated in FIG. 1, the workstation may be implemented as an aggregation of a plurality of workstations.

The video capture and playback system 100 further includes at least one client device 164 connected to the network 140. The client device 164 is used by one or more users to interact with the video capture and playback system 100. Accordingly, the client device 164 includes at least one display device and at least one user input device (such as, for example, a mouse, keyboard, or touchscreen). The client device 164 is operable to display on its display device a user interface for displaying information, receiving user input, and playing back video. For example, the client device may be any one of a personal computer, laptops, tablet, personal data assistant (PDA), cell phone, smart phone, gaming device, and other mobile device.

The client device 164 is operable to receive image data over the network 140 and is further operable to playback the received image data. A client device 164 may also have functionalities for processing image data. For example, processing functions of a client device 164 may be limited to processing related to the ability to playback the received image data. In other examples, image processing functionalities may be shared between the workstation 186 and one or more client devices 164.

In some examples, the image capture and playback system 100 may be implemented without the workstation 156. Accordingly, image processing functionalities may be wholly performed on the one or more video capture devices 108. Alternatively, the image processing functionalities may be shared amongst two or more of the video capture devices 108, processing appliance 148 and client devices 164.

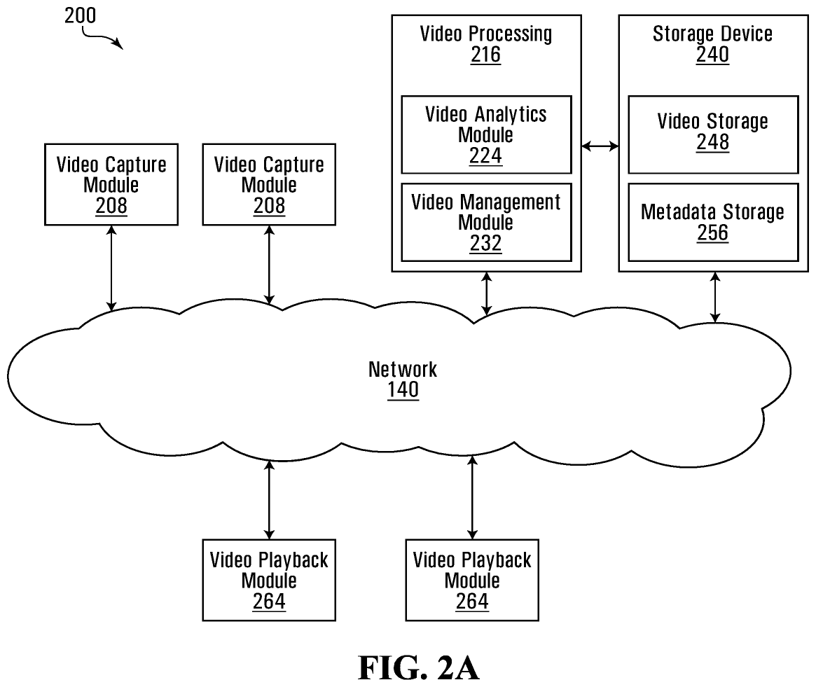

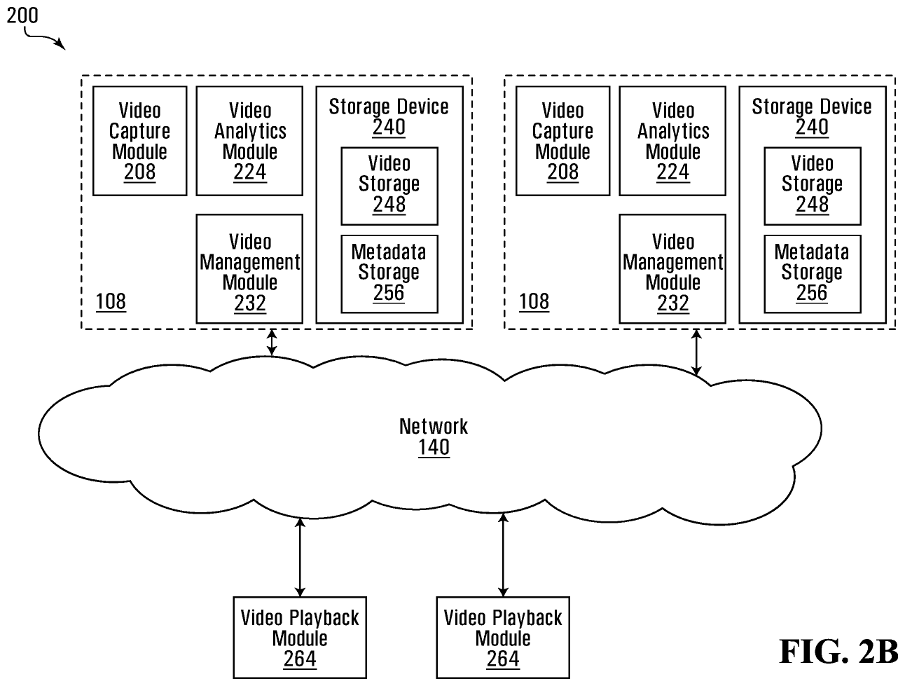

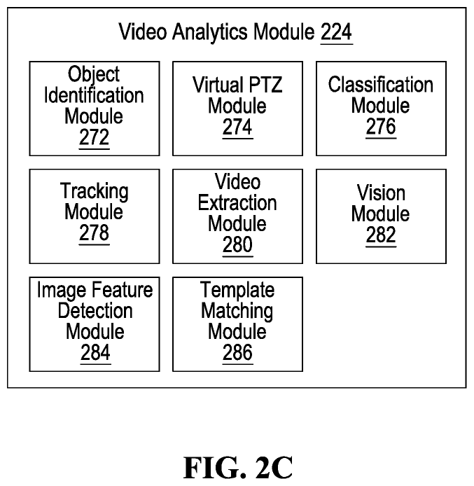

Referring now to FIG. 2A, therein illustrated is a block diagram of a set 200 of operational modules of the video capture and playback system 100 according to one example embodiment. The operational modules may be implemented in hardware, software or both on one or more of the devices of the video capture and playback system 100 as illustrated in FIG. 1.

The set 200 of operational modules include at least one video capture module 208. For example, each video capture device 108 may implement a video capture module 208. The video capture module 208 is operable to control one or more components (such as, for example, sensor 116) of a video capture device 108 to capture images.

The set 200 of operational modules includes a subset 216 of image data processing modules. For example, and as illustrated, the subset 216 of image data processing modules includes a video analytics module 224 and a video management module 232.

The video analytics module 224 receives image data and analyzes the image data to determine properties or characteristics of the captured image or video and/or of objects found in the scene represented by the image or video. Based on the determinations made, the video analytics module 224 may further output metadata providing information about the determinations. Examples of determinations made by the video analytics module 224 may include one or more of foreground/background segmentation, object detection, object tracking, object classification, virtual tripwire, anomaly detection, facial detection, facial recognition, license plate recognition, identifying objects “left behind” or “removed”, unusual motion, and business intelligence. However, it will be understood that other video analytics functions known in the art may also be implemented by the video analytics module 224.

The video management module 232 receives image data and performs processing functions on the image data related to video transmission, playback and/or storage. For example, the video management module 232 can process the image data to permit transmission of the image data according to bandwidth requirements and/or capacity. The video management module 232 may also process the image data according to playback capabilities of a client device 164 that will be playing back the video, such as processing power and/or resolution of the display of the client device 164. The video management module 232 may also process the image data according to storage capacity within the video capture and playback system 100 for storing image data.

It will be understood that according to some example embodiments, the subset 216 of video processing modules may include only one of the video analytics module 224 and the video management module 232.

The set 200 of operational modules further include a subset 240 of storage modules. For example, and as illustrated, the subset 240 of storage modules include a video storage module 248 and a metadata storage module 256. The video storage module 248 stores image data, which may be image data processed by the video management module. The metadata storage module 256 stores information data output from the video analytics module 224.

It will be understood that while video storage module 248 and metadata storage module 256 are illustrated as separate modules, they may be implemented within a same hardware storage whereby logical rules are implemented to separate stored video from stored metadata. In other example embodiments, the video storage module 248 and/or the metadata storage module 256 may be implemented using hardware storage using a distributed storage scheme.

The set of operational modules further includes at least one video playback module 264, which is operable to receive image data and playback the image data as a video. For example, the video playback module 264 may be implemented on a client device 164.

The operational modules of the set 200 may be implemented on one or more of the image capture device 108, processing appliance 148, workstation 156 and client device 164. In some example embodiments, an operational module may be wholly implemented on a single device. For example, video analytics module 224 may be wholly implemented on the workstation 156. Similarly, video management module 232 may be wholly implemented on the workstation 156.

In other example embodiments, some functionalities of an operational module of the set 200 may be partly implemented on a first device while other functionalities of an operational module may be implemented on a second device. For example, video analytics functionalities may be split between one or more of an image capture device 108, processing appliance 148 and workstation 156. Similarly, video management functionalities may be split between one or more of an image capture device 108, processing appliance 148, client device 164, and workstation 156.

Referring now to FIG. 2B, therein illustrated is a block diagram of a set 200 of operational modules of the video capture and playback system 100 according to one particular example embodiment wherein the video analytics module 224, the video management module 232 and the storage 240 is wholly implemented on the one or more image capture devices 108. Alternatively, the video analytics module 224, the video management module 232 and the storage 240 is wholly or partially implemented on one or more processing appliances 148, client devices 164, and/or workstations 156.

It will be appreciated that allowing the subset 216 of image data (video) processing modules to be implemented on a single device or on various devices of the video capture and playback system 100 allows flexibility in building the system 100.

For example, one may choose to use a particular device having certain functionalities with another device lacking those functionalities. This may be useful when integrating devices from different parties (such as, for example, manufacturers) or retrofitting an existing video capture and playback system.

In accordance with embodiments of the disclosure, and with reference to FIGS. 2C and 3-7, there will now be described methods and systems for initiating a video stream that may be used to track an object of interest. In the context of the present disclosure, when referring to the initiation of a video stream, the disclosure is referring to the fact that the video stream (in particular a secondary video stream) is newly generated, i.e., the video stream is a new video stream that previously was not being generated.

As described above, a user may wish to track movement of an object of interest. However, an object of interest may be stationary for long periods of time prior to moving. It would therefore be highly inefficient for a user to manually observe the non-moving object of interest until such a time that they begin moving. Therefore, in accordance with the present disclosure and with reference to FIG. 2C, video analytics module 224 includes an object identification module 272, a virtual pan-tilt-zoom (PTZ) module 274, a classification module 276, a tracking module 278, a video extraction module 280, a vision module 282, an image feature detection module 284, and a template matching module 286. Collectively, these modules are used to detect or identify an object of interest within a selected portion of a primary video stream, classify the object of interest, notify the user once movement (or some other event) of the object of interest is detected, and initiate a secondary video stream that is used to track subsequent movement of the object of interest.

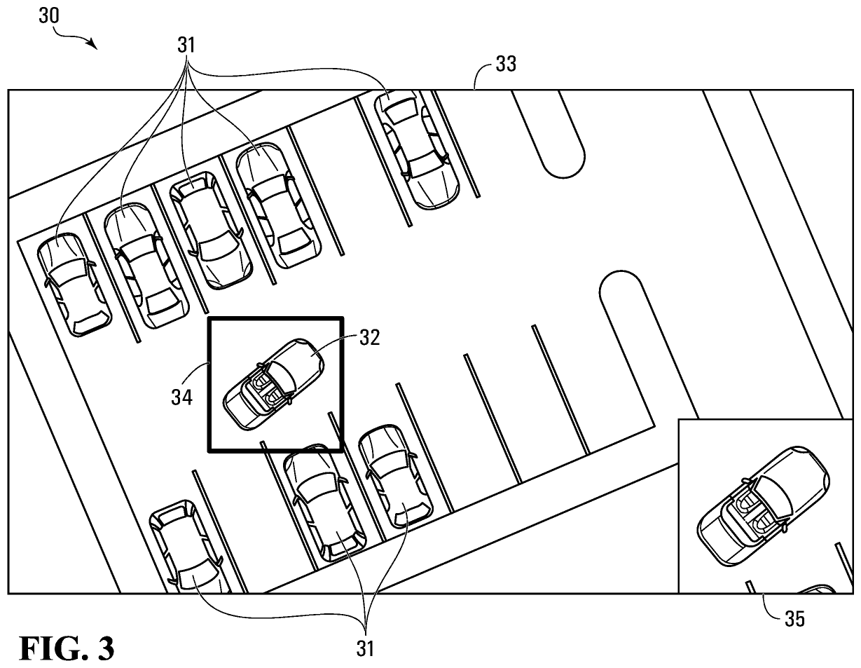

Turning to FIG. 3, there is shown a field of view 33 of a primary video stream 30 obtained using one of video capture devices 108. Primary video stream 30 may depict a static view of an area, or it may include camera motion or other changes over time, in which case field of view 33 changes with the motion of the camera. The field of view refers to the visible area contained within the imagery of primary video stream 30. Within field of view 33 of primary video stream 30 there can be seen multiple non-moving or stationary objects 31 (e.g. stationary vehicles) and at least one moving object 32 (e.g. moving vehicles). As mentioned above, a user may wish to track one or more non-moving objects without having (for potentially extended periods of time) to manually check whether the object is still non-moving or has begun to move. In order to do so, the user initiates one or more secondary video streams. A secondary video stream 35 is already displayed in the bottom right-hand corner of field of view 33. The field of view of secondary video stream 35 corresponds to the image portion within a bounding box 34 around moving vehicle 32.

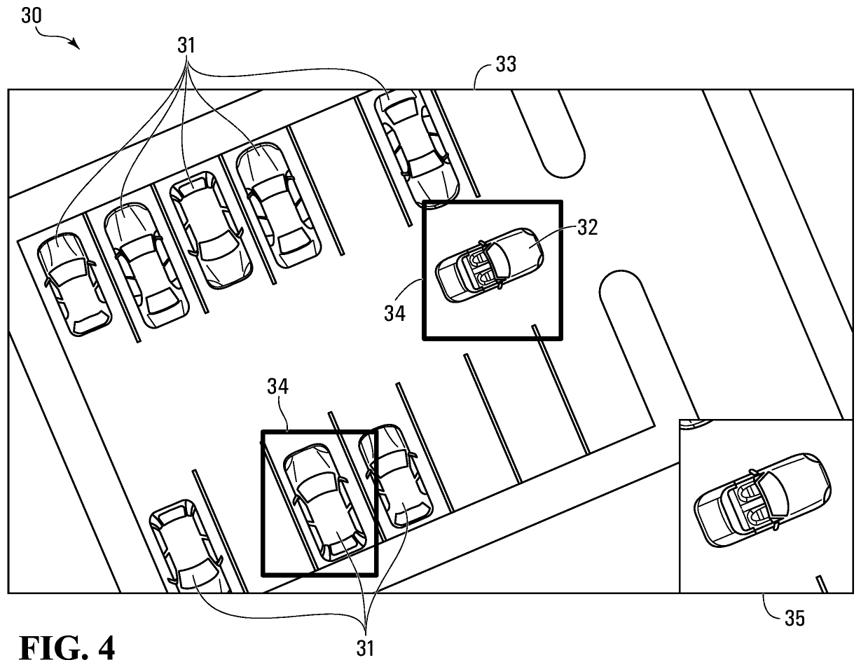

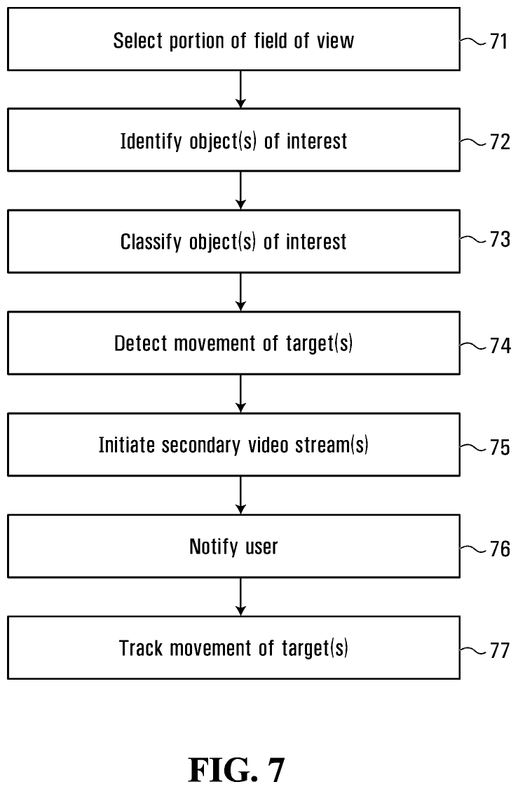

Turning to FIG. 7, there is shown a flow diagram of method of initiating a video stream for tracking an object of interest, according to an embodiment of the disclosure. In particular, at block 71 the user selects a portion of field of view 33 of primary video stream 30. Selection of the portion of field of view 33 may take various different forms. For example, the user may define a bounding box 34 (as shown in FIG. 4) that surrounds the non-moving object of interest (a vehicle in FIG. 4). The bounding box is typically rectangular in shape, but may also have an irregular shape which closely outlines the object of interest. A bounding box may, for example, closely follow the boundaries (outline) of a human or vehicular object. In some embodiments, the size of the bounding box may be varied by the user actuating a user input device, such as by using a computer mouse.

Once the video analytics module 224 has received the selected portion of field of view 33 (referred to hereinafter as a “selected image portion”), at block 72 one or more objects of interest are identified (e.g. detected) within the selected image portion. The detection is performed by object identification module 272 which may employ any known object detection method such as blob detection. Object identification module 272 may include the systems and use the detection methods described in U.S. Pat. No. 7,627,171 entitled “Methods and Systems for Detecting Objects of Interest in Spatio-Temporal Signals,” the entire contents of which is incorporated herein by reference.

Change detection algorithms may be used to attempt to identify stationary pixels by looking for changes between incoming frames and a background model. Over time, a sequence of frames may be analyzed, and a background model may be built that represents the normal state of the scene. When pixels exhibit behavior that deviates from the background model, they may be identified as foreground. As an example, a stochastic background modeling technique, such as the dynamically adaptive background subtraction techniques described in Lipton, Fujiyoshi, and Patil and in commonly-assigned U.S. Pat. No. 6,954,498 (herein incorporated by reference in its entirety), may be used. A combination of multiple foreground segmentation techniques may also be used to provide more robust results.

In one example embodiment of object detection, object detection may be carried out by comparing the selected image portion to a stored image of the background. For example, if the selected image portion corresponds to a parking space with a parked vehicle, the parked vehicle may be detected by comparing the selected image portion including the parked vehicle to an image of the parking space without the parked vehicle. Alternatively, the selected image portion may be segmented into foreground areas and background areas. The segmenting separates areas of the selected image portion corresponding to previously moving objects in the captured scene from stationary areas of the scene. One or more foreground visual objects in the selected image portion may then be detected based on the segmenting. In particular, foreground segmentation may be followed by “blobizing”, or “Connected Components Analysis”. Blobizing may be used to group foreground pixels into coherent blobs corresponding to possible targets. Any technique for generating blobs can be used. For example, the approach described in Lipton, Fujiyoshi, and Patil may be used. The results may be used to update a scene model with information about what regions in the image are determined to be part of coherent foreground blobs. Metadata may be further generated relating to the detected one or more foreground areas. The metadata may define the location, reference coordinates, classification, or attributes of the foreground visual object, or object, within the selected image portion.

Once an object has been detected within the selected image portion, at block 73, classification module 276 classifies each detected object. For example, pattern recognition may be carried out to classify each detected object. A detected object may be classified by class, such as a person, a car or an animal. Additionally or alternatively, an object may be classified by action, such as movement and direction of movement of the object (in the case where the detected object is already moving at the time the image portion is selected). Other classifiers may also be determined, such as color, size, orientation, etc. In more specific examples, classifying the object may include identifying a person based on facial detection and recognizing text, such as a license plate. Visual classification may be performed according to systems and methods described in co-owned U.S. Pat. No. 8,934,709, which is incorporated by reference herein in its entirety. Generally, classification can be performed by a number of techniques, and examples of such techniques include using a neural network classifier and using a linear discriminant classifier, both of which are described, for example, in Collins, Lipton, Kanade, Fujiyoshi, Duggins, Tsin, Tolliver, Enomoto, and Hasegawa, “A System for Video Surveillance and Monitoring: VSAM Final Report”, Technical Report CMU-RI-TR-00-12, Robotics Institute, Carnegie-Mellon University, May 2000.

In the case of FIG. 4, the object of interest is identified as a vehicle, contained within bounding box 34. In what follows, the vehicle of interest is referred to as a “target”. In some embodiments, virtual PTZ module 274 may determine the ultimate size of the selected image portion. For example, a user may select a portion of field of view 33 and, in response thereto, virtual PTZ module 274 may adjust the size of the selected image portion based on one or more objects or targets identified within the selected image portion. For instance, identification of a vehicle in the selected image portion may cause virtual PTZ module 274 to adjust the selected image portion accordingly, such that the vehicle is properly framed by virtual PTZ module 274. In addition, whereas a vehicle may have a horizontally-oriented selected image portion, a person may have a vertically-oriented selected image portion.

After selection of the image portion, at block 74, virtual PTZ module 274 detects when the target begins to move. More generally, virtual PTZ module 274 may detect when an event has occurred within the selected image portion. Examples of detectable events include, but are not limited to, motion within the selected image portion, crossing a virtual tripwire in the selected image portion, the target disappearing from the selected image portion, and an item being inserted or removed from the selected image portion (for example if, in the case of a person, the target reveals an item from a coat pocket). The definition of an event may be configurable by a user.

Virtual PTZ module 274 may use any of various methods of detecting movement of a target. For example, as mentioned above, incoming frames from primary video stream 30 may first undergo foreground segmentation, whereby the frames are analyzed and regions of the frame that correspond to foreground objects are detected. Pixels may be segmented in registered imagery into background and foreground regions. Background regions include areas of the scene that are typically not changing their content significantly from frame to frame; such areas may include, for example, static background areas, such as the wall of a building, as well as moving background areas, such as waving trees or ocean waves. Foreground regions include areas of the scene that include moving or stationary targets. These may include, for example, walking people and moving cars, as well as regions containing newly-modified objects, such as graffiti on a wall or a bag left in a road. Various common frame segmentation algorithms exist to distinguish the foreground and background regions. Motion detection algorithms detect only moving pixels by comparing two or more frames over time. As an example, the three frame differencing technique, discussed in A. Lipton, H. Fujiyoshi, and R. S. Patil, “Moving Target Classification and Tracking from Real-Time Video”, Proc. IEEE WACV '98, Princeton, N.J., 1998, pp. 8-14 (subsequently to be referred to as “Lipton, Fujiyoshi, and Patil”), can be used, and is herein incorporated by reference in its entirety.

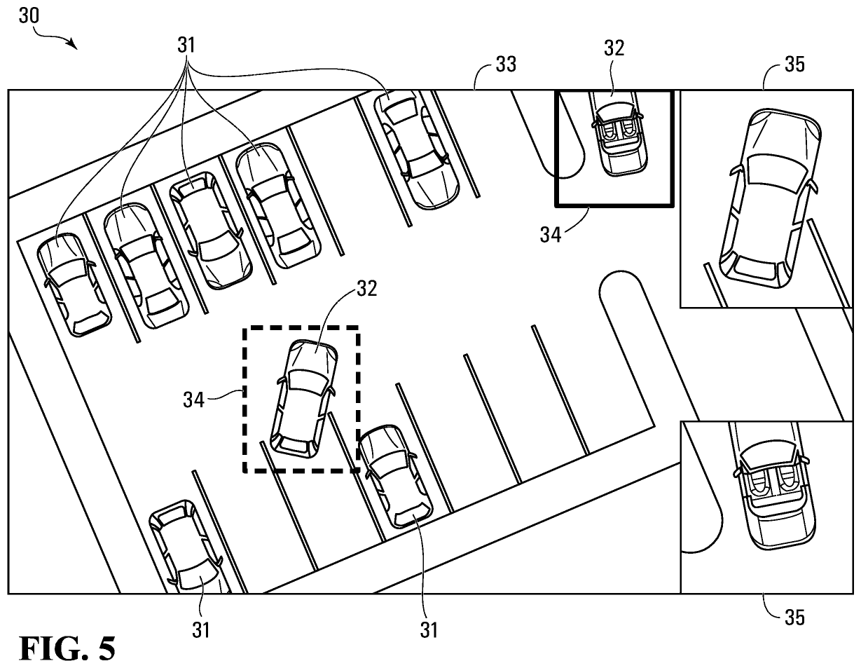

Returning to FIG. 7, in response to detecting movement of the target (or an event), at block 75, virtual PTZ module 274 initiates a secondary video stream 35 having a field of view that comprises the selected image portion (FIG. 5). In particular, the field of view of secondary video stream 35 corresponds to the selected portion 34 of field of view 33 of primary video stream 30. Secondary video stream 35 is a virtual video stream generated based on primary video stream 30, by extracting data from primary video stream 30. In other words, no additional camera is required in order to generate secondary video stream 35. Of course, in some embodiments secondary video stream 35 may be generated using one or more additional cameras.

By selecting multiple portions of field of view 33 of primary video stream 30, the user may identify multiple areas or zones of interest. In response to any movement or any event being detected in any one of the selected image portions, virtual PTZ module 274 may initiate a secondary video stream as described above. Thus, multiple secondary video streams sourced from the same primary video stream may be initiated, in response to multiple image portions being selected in field of view 33. In cases where more than one object of interest is identified in the selected image portion, and multiple ones of the identified objects of interest begin to move, virtual PTZ module 274 may initiate a single secondary video stream capturing each moving object of interest. Subsequently, once the current field of view of the secondary video stream can no longer capture the moving objects of interest, the field of view of the secondary video stream may be adjusted so as to track all moving objects in the secondary video stream. In some embodiments, primary video stream 30 may be obtained in high-definition, such as from a high-definition or ultra-high-definition image capture device. By providing a primary video stream with a high resolution, secondary video streams initiated using virtual PTZ module 274 may still be of relatively high resolution.

As discussed below, various methods may be used by virtual PTZ module 274 to initiate secondary video stream 35. These methods are also discussed in more detail in U.S. Pat. No. 9,524,437.

An exemplary manner in which secondary video stream 35 is generated is by extracting part of an image from each frame of primary video stream 30 in order to produce a smaller frame covering the selected image portion. Depending on configurations or desired user settings, the image size of secondary video stream 35 may be fixed or may vary based on target size.

Video extraction module 280 may be used to generate one or more secondary video streams 35 from primary video stream 30 and may also generate selective video analytics results. Video extraction module 280 may exist as a software module embodied on a computer-readable medium, embedded hardware running said software, for example, in devices such as video cameras or digital video recorders (DVRs), or in the form of special-purpose hardware (for example, an application-specific integrated circuit (ASIC) or a programmed programmable gate array (PGA)) designed to implement the extraction method. Video cameras and digital video recorders are simply two exemplary devices in which extraction modules may be embedded. It would be possible to embed video extraction module 280 on any number of devices that may be used to process video streams. Video extraction module 280 may use the same video stream as used by the other modules of video analytics module 224 to create secondary video stream 35, or it may use a copy of secondary video stream 35. In the example of video extraction module 280 residing on a computer-readable medium and being run on a computer, primary video stream 30 may exist as an in-memory video buffer, while in the example where video extraction module 280 is embedded in a hardware device, such as a video camera, primary video stream 30 may be obtained directly from the video camera's charge-coupled device (CCD) array.

To create secondary video streams, video extraction module 280 may accept as input a set of data describing targets, events, and/or areas of interest in primary video stream 30, as reported by video analytics module 204. This input data may contain information describing zero or more targets in primary video stream 30. The exact number of targets of interest will be dictated by the number of objects in the scene of primary video stream 30, the actions of said objects, and a set of requirements supplied to video analytics module 204 by either a manual operator or the video surveillance system as a whole. The information describing each target in primary video stream 30 may include, but is not limited to, a bounding box describing the location and size of the target in relation to the imagery making up primary video stream 30, a footprint describing the x-y location of the base of the target in relation to primary video stream 30, and a classification describing the type of target as interpreted by video analytics module 204. Possible classifications for a target may include, but are not limited to, human or vehicle.

Video extraction module 280 may use all, some, or none of the data supplied in the analysis results to initiate secondary video stream 35. One exemplary embodiment of video extraction module 280 could be the initiation of a “best-shot” video stream describing one or more targets of interest. Knowing that the best view of a target may vary depending on its type, video extraction module 280 could vary the extraction algorithms based on a target's classification. For example, the best-shot for a target of human classification may be a video stream clearly depicting the subject's face. In this instance, video extraction module 280 may, for example, initiate a secondary video stream using the top 1/7^{th} of the target's bounding box. In another exemplary embodiment, video extraction module 280 could receive analysis results in which the targets are of classification type vehicle. In this instance, the best-shot for a target of vehicle classification might include the region surrounding the target's license plate, allowing for vehicle identification. For this type of target, the video extraction module might use the bounding box of the target, as supplied by video analytics module 204, to extract the frontal region of the target, and use the extracted data to initiate a secondary video stream. Other techniques for extracting best shots, such as those described in US patent publication US 2005/0104958, may also be used.

Another embodiment of video extraction module 280 may involve a more complicated method of determining the region to extract into a secondary video stream given information about targets of interest. In addition to the analysis results that may be supplied by video analytics module 204, video extraction module 280 could also receive a set of configuration information from an external source. This configuration, or calibration, could dictate how video extraction module 280 would create the secondary video stream. This calibration information may be created manually by a user and supplied to video extraction module 280 at initialization or another point of the module's life-cycle. Alternatively, calibration information may be created manually by a user once and stored on a computer-readable medium for use across one or more sessions of video extraction module 280. By supplying a calibration set to video extraction module 280, greater flexibility could be achieved in extracting and initiating secondary video streams. Take, for example, a primary video stream coming from a wide-angle video camera that is monitoring a moderately traveled pedestrian walkway. In this scenario, video extraction module 280 could be used to create best-shot video streams of targets of interest. However, for this particular scenario, the best-shot may vary according to the target's orientation. Specifically, if the target of interest is traveling towards the video camera that is providing the primary video stream, the best-shot could be a video stream clearly displaying the subject's face. However, if the target is travelling away from the video camera providing the primary video stream, the subject's face would not be visible in the primary video stream, and the best-shot could be a wider-angle view of the subject. By supplying a calibration set to video extraction module 280, a user may be able to dictate that video extraction module 280 initiate a secondary stream that is centered tightly on the target's face when the target's velocity vector is traveling in the direction of the primary video stream. When the target's velocity vector is traveling away from the primary video stream, the same calibration set could be used by video extraction module 280 to create a secondary video stream that displays more details on the subject, such as clothing and body dimensions.

In another embodiment, the primary video stream may be supplied to video analytics module 204 in a specific video resolution. Video analytics module 204 may process the primary video stream at this resolution and supply results to video extraction module 280 in a coordinate system using the same resolution. Alternatively, video analytics module 204 may opt to supply analysis results to video extraction module 280 in a relative coordinate system, by normalizing the results against the pixel resolution of the primary video stream. For example, video analytics module 204 may receive the primary video stream from a video camera at a 320×240 pixel resolution. Video analytics module 204 may process the primary video stream at the same resolution and supply to video extraction module 280 the analysis results in an absolute coordinate system based on the 320×240 pixel resolution. In this scenario, video extraction module 280 could use the analysis results in absolute coordinates, to extract a secondary video stream from the primary video stream at a pixel resolution of 320×240. Alternatively, if video analytics module 204 opted to supply analysis results in a relative coordinate system, video extraction module 280 could still use the supplied results to extract a secondary video stream from the primary video stream at 320×240 pixel resolution. In this particular example, the secondary video stream extracted using the absolute coordinate system and the secondary video stream extracted using the relative coordinate system are likely to be very similar for a given target of interest, as long as the extraction was performed on the same pixel resolution primary video stream in both cases.

In another embodiment, the primary video stream may be supplied in a specific high-resolution format. For optimization purposes, video analytics module 204 may opt to down-sample the primary video stream to a lower resolution, before processing the video stream for targets of interest, event detection, and changes to the scene. For example, the primary video stream may be generated from a video camera that has a pixel resolution of 640×480. In order to optimize the resources used on the device performing the analysis, video analytics module 204 may down-sample the 640×480 video stream to a lower quality 320×240 pixel resolution before performing the analysis process. In this scenario, video extraction module 280 may either receive the analysis results in a relative coordinate system, where target information has been normalized by video analytics module 204, in a coordinate system scaled to the primary video stream before being down-sampled, e.g., 640×480, or in a coordinate system scaled to the primary stream after being down-sampled, e.g., 320×240.

Regardless of how the analysis results are provided to video extraction module 280, either the unmodified primary video stream or the down-sampled video stream may be used to extract the secondary video stream. For example, suppose that a down-sampled video stream is used to extract and then initiate the secondary video stream. Based on the 320×240 resolution of the down-sampled video stream, video analytics module 204 has supplied to video extraction module 280 target dimensions of 10×30 pixels. In this situation, video extraction module 280 may opt to extract the region surrounding the target of interest from the down-sampled video stream and initiate a secondary video stream from the 10×30 sub-region. However, if this particular implementation needs a greater level of detail, video extraction module 280 may opt to use the unmodified primary video stream to extract and then initiate a higher quality secondary video stream. In this case, video extraction module 280, to obtain an equivalent-size region, would extract a 20×60 safe-region around the target of interest, thereby providing a more detailed view of the subject.

Video extraction input data may also contain information about areas of interest in the scene, for example, portions of a road undergoing abnormal traffic patterns. Information, such as the area location and extent in the input video stream imagery, may be used by video extraction module 280 to initiate a secondary video stream. Similar techniques to those described above for extracting feeds based on targets of interest may also be used for these cases where events or areas of interest are to be targeted.

Returning to FIG. 7, in addition to initiating secondary video stream 35, at block 76, virtual PTZ module 274 notifies the user of the movement of the target. In particular, virtual PTZ module 274 causes secondary video stream 35 to be displayed concurrently to primary video stream 30. As can be seen in FIG. 5, secondary video stream 35 is shown adjacent primary video stream 30. In an embodiment, the field of view of secondary video stream 35 corresponds to (i.e. is the same size as) selected image portion 34. In some embodiments, the field of view of secondary video stream 35 corresponds to a “best-shot” field of view, as described above. In some embodiments, virtual PTZ module 274 may display additionally or alternatively a notification on a display, and/or may play an audible tone. The notification might include information about the target that engaged in the particular event, including, for example, their location, direction, and appearance.

At block 77, tracking module 278 causes secondary video stream 35 to track movement of the target. In particular, once the target is determined to be in motion, tracking module 278 causes secondary video stream 35 to follow the target by adjusting the field of view of secondary video stream 35 such that the target is kept within the field of view of secondary video stream 35. Specifically, the field of view may undergo one or more of virtual zooming, panning and tilting in order to track the target. For example, if the target moves toward the left or right of the field of view, the field of view of secondary video stream 35 may be panned in order to follow the target. If the target moves toward the top or bottom of the field of view, the field of view of secondary video stream 35 may be tilted in order to follow the target. And if the target moves away from or toward the virtual camera, the field of view of secondary video stream 35 may be zoomed in or out in order to follow the target. In addition, tracking module 278 may use template-based tracking to identify non-human objects, such as an inanimate object or an animal. Suitable template tracking algorithms that may be used are known to those of skill in the art.

Various methods may be used by tracking module 278 to track the moving target. These methods are also discussed in more detail in U.S. Pat. No. 9,524,437.

For example, in one particular embodiment, vision module 282 may be used to process incoming video and to generate summary statistics describing the video content. In order to keep a detailed view of a moving target of interest in a secondary video stream, video extraction module 280 may, for example, be directed to always extract a chunk of imagery that keeps the target of interest in the center of the camera view.

Scene motion estimation may be performed and may attempt to find both camera motion and the motion of the target being tracked. Camera motion estimation may typically involve analyzing incoming frames to determine how the camera or field of view was moving when they were generated. Because a secondary video stream extracted from a primary video stream may be generated by video extraction module 280, information about how the frames relate to each other may be known. Video extraction module 280 may record or output the source position of each secondary video frame in each primary video frame, and this information can be used to infer the relative motion between frames. However, depending on the particular implementation of the system, this information may not be available, or it may come with a certain amount of delay that might make it unusable for real-time applications. For this reason, it may be necessary to estimate the relative camera motion between frames based solely on the content of the secondary video stream.

Many state-of-the-art algorithms exist to perform camera motion estimation. One such technique is described in U.S. Pat. No. 6,7351,424. Many common techniques make use of a scene model, for example, a background mosaic, as a way to aid in camera motion estimation. Another technique is described in U.S. patent application Ser. No. 11/222,223, filed Sep. 9, 2003, hereinafter referred to as US patent publication US 2006/0255998. One potential drawback of these techniques is that they may perform best when the scene being analyzed consists mainly of stationary background. When processing a secondary video stream that has been extracted from a primary video stream, it is assumed that the tracked target of interest will mostly likely take up more of the scene in the secondary video stream than in the primary video stream. This, in turn, may leave fewer distinguishable background features, which are usually one of the main inputs to typical camera motion estimation algorithms. For this reason, it may be desirable to use a camera motion estimation technique that attempts to also distinguish the motion of the target being tracked. One common approach is to use an optical flow technique to look at the motion of some or all pixels in the scene. The dominant motion will generally be the camera motion; the second most dominant will generally be the target motion. Another technique is described in US patent publication US 2005/0104958. Note that a scene model may be used to initialize this motion estimation; when first beginning to process a secondary video stream, some information may be known about the area of the scene where the target is located. For example, a portion of a background mosaic containing information about the background region behind the target may be used to aid in camera motion estimation.

Once the camera motion has been determined, then the relationship between successive frames is known. This relationship might be described through a camera projection model consisting of, for example, an affine or perspective projection. Incoming video frames from a moving secondary video stream can then be registered to each other so that differences in the scene (e.g. foreground pixels or moving objects) can be determined without the effects of the camera motion. Frames may be registered to a common reference through a camera motion compensation module. Successive frames may be registered to each other or may be registered to a scene model, which might, for example, be a background mosaic. A technique that uses a scene model in this way is described in US patent publication US 2006/0255998.

Aligned frames may next go to a foreground segmentation module, which may analyze the frames and may detect the regions of the frame that correspond to foreground objects. Note that, as in previous steps, a scene model might be used to aid in this process. Due to the decreased number of background pixels likely visible in a scene focused on a foreground object, it is possible that the results of the foreground segmentation module may be relatively less accurate. For this reason, the foreground pixels output from foreground segmentation module may form only one input to a template matching module.

Image feature detection module 284 may be used to detect features in the secondary video stream that may provide cues as to where in each frame the moving target of interest is located. For example, edges or texture patches may be detected near the area where the target is predicted to be. As another example, intensity or color histograms might be extracted from areas in the scene. A target model, which may contain a current model of the tracked target's appearance and motion characteristics, might be used to initialize the algorithms for image feature detection. Initialization of the target model might use information from the last known appearance of the target when extraction of the secondary video stream began.

Template matching module 286 may perform template matching and may be used to attempt to identify the location of the target being tracked in the incoming frames of the moving secondary video stream. A variety of cues may be used to do this, including target motion, foreground segmentation, and/or image features. Other calculable features might also be used to form a template that describes the current appearance of the target being tracked. A current model of the tracked target's appearance and motion characteristics may be contained in the target model; this model may be used to match against different areas of the image in order to find the target's location. An approach such as the one described in US patent publication US 2005/0104958 might be used to weigh the different features in order to compute the best match. Ideally, an approach that is robust to different camera motions and changes in the target's appearance should be used; however, the disclosure is not limited to this approach. Once the target has been located in the latest image, the target model may be updated so that it contains updated information about the target.

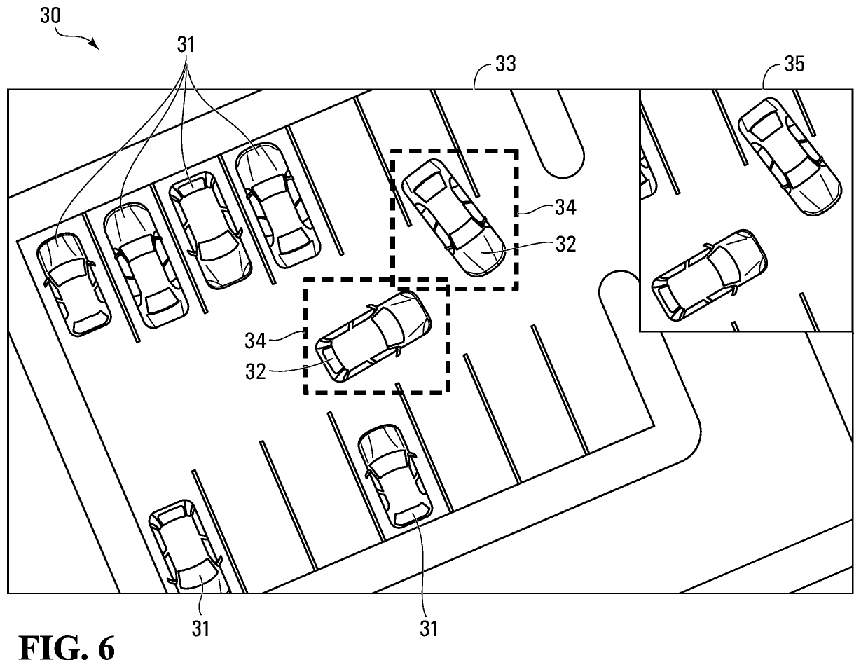

In the case of the user selecting multiple image portions, and an event being detected in each selected image portion, a given secondary video stream may be initiated such that more than one of the selected image portions is comprised in the field of view of the secondary video stream. For example, if two individual targets are determined to be moving, then, rather than initiating separate secondary video streams to track each target individually, a single secondary video stream may be initiated such that the field of view of the secondary video stream encompasses both targets. For example, as can be seen in FIG. 6, the user has identified two separate image portions by means of bounding boxes 34, each containing a single target, but a single secondary video stream 35 encompasses both targets 32 (and in particular both bounding boxes 34).

In some embodiments, in response to events being detected in first and second selected image portions of field of view 33 of primary video stream 30, the field of view of a secondary video stream tracking the event in the first selected image portion may be zoomed outwards so as to additionally encompass the second selected image portion. Thus, a single secondary video stream is used to track multiple objects, the objects having been initially identified in separate, respective selected image portions.

Virtual PTZ module 280 may work in conjunction with other modules in video analytics module 204 in order to better track a moving target. For example, once the target exits field of view 33 of primary video stream 30, it may no longer be possible for primary video stream 30 to be used to track the target (assuming the camera generating primary video stream 30 is unable to tack the target). Once virtual PTZ module 280 determines that the target has exited field of view 33, an appearance search engine, for example as described in PCT publication WO 2018/102919 (the contents of which is hereby incorporated by reference in its entirety), may be executed on other objects identified in other video streams obtained from other cameras. In particular, signatures of the target may be compared to signatures of objects in other video streams, in order to identify an object that is most likely to be the same as the target. Once the target has been re-identified in another video stream, virtual PTZ module 280 may initiate a secondary video stream as described above, based on the other video stream in which the target has been re-identified.

In some embodiments, the target may be re-acquired in another video stream based on one or more of a speed of an object in the other video stream, and a direction of travel of an object in the other video stream.

It is contemplated that any part of any aspect or embodiment discussed in this specification can be implemented or combined with any part of any other aspect or embodiment discussed in this specification.

While the above description provides examples of the embodiments, it will be appreciated that some features and/or functions of the described embodiments are susceptible to modification without departing from the spirit and principles of operation of the described embodiments. Accordingly, what has been described above has been intended to be illustrated non-limiting and it will be understood by persons skilled in the art that other variants and modifications may be made without departing from the scope of the invention as defined in the claims appended hereto. Furthermore, any feature of any of the embodiments described herein may be suitably combined with any other feature of any of the other embodiments described herein.

1. A method comprising:
receiving a selection of a portion of a field of view of a primary video stream;
identifying an object of interest within the portion that has been selected;
detecting, in the selected portion, an event associated with the object of interest; and
in response to detecting the event, initiating a secondary video stream having a field of view that comprises the selected portion.

2. The method of claim 1, wherein the field of view of the secondary video stream corresponds to the selected portion.

3. The method of claim 1, wherein receiving the selection of the portion comprises receiving a selection of a boundary defining the portion of the field of view of the primary video stream.

4. The method of claim 1, further comprising classifying the object of interest.

5. The method of claim 1, wherein the event comprises movement of the object of interest.

6. The method of claim 1, further comprising adjusting the field of view of the secondary video stream so as to track movement of the object of interest.

7. The method of claim 6, wherein adjusting the field of view comprises one or more of panning the field of view, tilting the field of view, and zooming the field of view.

8. The method of claim 1, further comprising displaying the secondary video stream.

9. The method of claim 8, wherein the secondary video stream is displayed concurrently to display of the primary video stream.

10. The method of claim 1, further comprising:
receiving one or more additional selections of portions of the field of view of the primary video stream;
identifying one or more additional objects of interest within the one or more portions that have been additionally selected; and
detecting one or more additional events in the one or more additional selected portions.

11. The method of claim 10, further comprising, in response to detecting the one or more additional events, initiating one or more additional secondary video streams each having a field of view that comprises at least one of the one or more additional selected portions.

12. The method of claim 10, further comprising, in response to detecting the one or more additional events, adjusting the field of view of the secondary video stream so as to track movement of the object of interest and movement of an additional object of interest within at least one of the one or more additional selected portions.

13. The method of claim 1, further comprising:
determining that the object of interest has exited a maximum field of view of the primary video stream;
generating one or more signatures of the object of interest;
generating one or more signatures of one or more identified objects in one or more other video streams;
comparing the one or more signatures of the one or more identified objects with the one or more signatures of the object of interest to generate similarity scores for the one or more identified objects; and
based on the similarity scores, initiating one or more additional secondary video streams each having a field of view that comprises at least one of the one or more identified objects.

14. The method of claim 1, further comprising:
prior to the object of interest exiting a maximum field of view of the primary video stream, determining one or more of a speed of the object of interest, a direction of travel of the object of interest, and one or more signatures of the object of interest;
determining that the object of interest has exited the maximum field of view;
in response to determining that the object of interest has exited the maximum field of view, identifying the object of interest in another video stream based on one or more of: a speed of an object in the other video stream, a direction of travel of an object in the other video stream, and one or more signatures of an object in the other video stream; and
initiating an additional secondary video stream having a field of view that comprises the identified object of interest.

15. A computer-readable medium having stored thereon computer program code configured when read by one or more processors to cause the one or more processors to perform a method comprising:
receiving a selection of a portion of a field of view of a primary video stream;
identifying an object of interest within the portion that has been selected;
detecting, in the selected portion, an event associated with the object of interest; and
in response to detecting the event, initiating a secondary video stream having a field of view that comprises the selected portion.

16. A system comprising:
a camera configured to generate a primary video stream; and
one or more processors communicative with memory and configured to:
receive a selection of a portion of a field of view of the primary video stream;
identify an object of interest within the portion that has been selected;
detect, in the selected portion, an event associated with the object of interest; and
in response to detecting the event, initiate a secondary video stream having a field of view that comprises the selected portion.

17. The system of claim 16, wherein the one or more processors and the memory are comprised in the camera.

18. The system of claim 16, wherein the camera is configured to transmit over a network the primary video stream to the one or more processors.

19. A method comprising:
displaying, on a display, a field of view of a primary video stream;
receiving, via a user input device, a selection of a portion of the field of view;
identifying an object of interest within the portion that has been selected;
detecting, in the selected portion, an event associated with the object of interest; and
in response to detecting the event, initiating, on the display, a secondary video stream having a field of view that comprises the selected portion.

20. The method of claim 19, wherein the field of view of the secondary video stream corresponds to the selected portion.

21. The method of claim 19, wherein receiving the selection of the portion of the field of view comprises receiving a selection of a boundary defining the portion of the field of view of the primary video stream.

22. The method of claim 19, further comprising classifying the object of interest.

23. The method of claim 19, wherein the event comprises movement of the object of interest.

24. The method of claim 19, further comprising adjusting, on the display, the field of view of the secondary video stream so as to track movement of the object of interest.

25. The method of claim 24, wherein adjusting the field of view comprises one or more of panning the field of view, tilting the field of view, and zooming the field of view.

26. The method of claim 19, wherein the secondary video stream is displayed concurrently to display of the primary video stream.

27. The method of claim 19, further comprising:
receiving, via a user input device, one or more additional selections of portions of the field of view of the primary video stream;
identifying one or more additional objects of interest within the one or more portions that have been additionally selected; and
detecting, in the one or more additional selected portions, one or more additional events associated with the one or more additional objects of interest.

28. The method of claim 27, further comprising, in response to detecting the one or more additional events, initiating, on a display, one or more additional secondary video streams each having a field of view that comprises at least one of the one or more additional selected portions.

29. The method of claim 27, further comprising, in response to detecting the one or more additional events, adjusting, on the display, the field of view of the secondary video stream so as to track movement of the object of interest and movement of an additional object of interest within at least one of the one or more additional selected portions.

30. The method of claim 19, further comprising:
determining that the object of interest has exited a maximum field of view of the primary video stream;
generating one or more signatures of the object of interest;
generating one or more signatures of one or more identified objects in one or more other video streams;
comparing the one or more signatures of the one or more identified objects with the one or more signatures of the object of interest to generate similarity scores for the one or more identified objects; and
based on the similarity scores, initiating, on a display, one or more additional secondary video streams each having a field of view that comprises at least one of the one or more identified objects.

31. The method of claim 19, further comprising:
prior to the object of interest exiting a maximum field of view of the primary video stream, determining one or more of a speed of the object of interest, a direction of travel of the object of interest, and one or more signatures of the object of interest;
determining that the object of interest has exited the maximum field of view;
in response to determining that the object of interest has exited the maximum field of view, identifying the object of interest in another video stream based on one or more of: a speed of an object in the other video stream, a direction of travel of an object in the other video stream, and one or more signatures of an object in the other video stream; and
initiating, on the display, an additional secondary video stream having a field of view that comprises the identified object of interest.
